(19) United States
(12) Patent Application Publication
(10) Pub. No.: US 2009/0091533 A1
(43) Pub. Date: Apr. 9, 2009

(54) Keyboard

(76) Inventors: Wen-Chuan Yang, Taichung City (TW); Chun-An Lin, Hsinchu City (TW); Su-Chen Chen, Taipei County (TW)

Correspondence Address: Dr. BANGER SHIA, 102 Lindencrest Ct., Sugar Land, TX, 77479-5201, US

(21) Appl. No.: 11/867,612

(22) Filed: Oct. 4, 2007

(51) Int. Cl. G09G 5/08

(52) U.S. Cl. 345/158

(57) ABSTRACT

A keyboard includes a control panel and a cursor controller. The cursor controller includes a first key unit provided on the control panel, a second key unit provided on the control panel and a photo-sensor unit provided on the control panel. When a user moves his finger over the photo-sensor unit, the photo-sensor unit senses the movement and causes a cursor to move on a screen of a display of a computer used with the keyboard.

### BACKGROUND OF INVENTION

1. Field of Invention

The present invention relates to a keyboard and, more particularly, to a keyboard provided with a cursor controller.

2. Related Prior Art

A computer includes a keyboard through which commands are executed and data are entered. While using a Windows, Linux or Macintosh operation system, a mouse is as important as the keyboard. Through the mouse, the cursor can efficiently be controlled and moved to an icon or words of hyperlink. After the selection of the icon of hyperlink, a series of commands or programs is executed.

A mouse is generally separate from a keyboard. A user operates the mouse with one hand such as the right hand. The user has to move the right hand between the mouse and the keyboard. This inevitably entails a low efficiency and inconvenience in operating the computer. On the other hand, the user often unconsciously stretches the right arm for a long distance while operating the mouse with the right hand. The user might get a sore arm after operating the mouse for some time. What s worse, the user might take a bad gesture and get tired and tense easily if operating the mouse improperly.

A touch panel is sometimes installed on a keyboard of a laptop computer. A user moves a finger on the touch panel to move a cursor on a screen of a display of the laptop computer. It is however difficult for the user to move the cursor precisely by moving his finger on the touch panel. On the other hand, the touch panel is often used with two buttons like that of a mouse. It is however difficult for the user to push the buttons because of their positions. Moreover, the touch panel lacks a scroll wheel, thus rendering it less favorable than a mouse. Hence, the user often carry a mouse together with a laptop computer although the laptop computer is equipped with a touch panel. It is however inconvenient for the user to carry the mouse.

The present invention is therefore intended to obviate or at least alleviate the problems encountered in prior art.

### SUMMARY OF INVENTION

It is an objective of the present invention to provide a keyboard with a cursor controller that enables a user to operate the keyboard at a high efficiency and with inconvenience.

It is another objective of the present invention to provide a keyboard with a cursor controller that enables a user to keep a good gesture while operating the keyboard.

It is another objective of the present invention to provide a keyboard with a cursor controller that can be carried conveniently.

To achieve the foregoing objectives of the present invention, a keyboard includes a control panel and a cursor controller. The cursor controller includes a first key unit provided on the control panel, a second key unit provided on the control panel and a photo-sensor unit provided on the control panel. When a user moves his finger over the photo-sensor unit, the photo-sensor unit senses the movement and causes a cursor to move on a screen of a display of a computer used with the keyboard.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of a keyboard according to a first embodiment of the present invention.

FIG. 2 is an exploded view of the key board shown in FIG. 1.

FIG. 3 is an exploded view of a keyboard according to a second embodiment of the present invention.

FIG. 4 is a perspective view of a laptop computer equipped with a keyboard according to a third embodiment of the present invention.

### DETAILED DESCRIPTION OF EMBODIMENTS

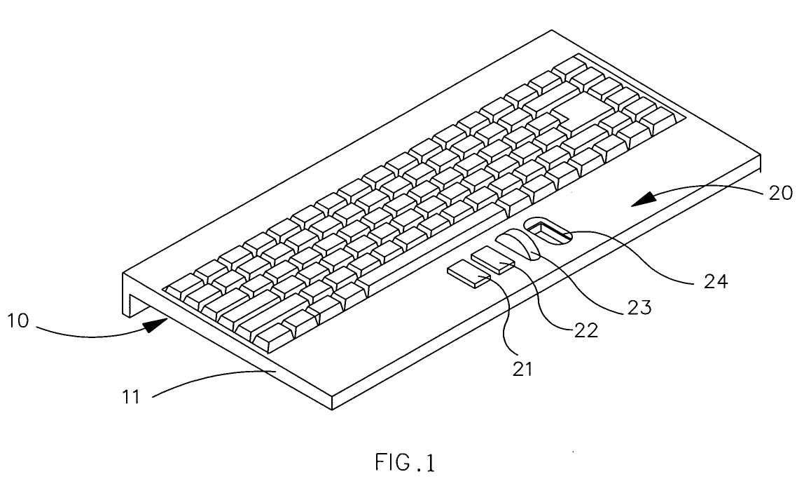

Referring to FIG. 1, a keyboard 10 includes a plurality of keys (the standard keys ) and a cursor controller 20 according to a first embodiment of the present invention. The keyboard 10 is intended for use with a desktop computer. The cursor controller 20 is located closer to a user than the standard keys are. Hence, the user can operate the cursor controller 20 with two thumbs while operating the standard keys with the other fingers.

The cursor controller 20 includes a first key unit 21, a second key unit 22, a scroll wheel unit 23 and an photo-sensor unit 24. The first key unit 21 can be made like a left key of a mouse so that it can be used as a select key. The second key unit 22 can be made like a right key of the muse and used as an enter key. The scroll wheel unit 23 is made like a scroll wheel of the mouse so that it can be used to scroll a screen of a display of a desktop computer. The photo-sensor unit 24 is made like an infrared sensor of the mouse so that it can be used to move a cursor on the screen. The functions of the first key unit 21, second key unit 22, scroll wheel unit 23 and photo-sensor unit 24 are not limited to those mentioned above, but can be defined in other manners by the user. The first key unit 21, second key unit 22, scroll wheel unit 23 and photo-sensor unit 24 are located sequentially from left to right in the first embodiment; they can however be located sequentially from right to left in another embodiment or in any other order in another embodiment.

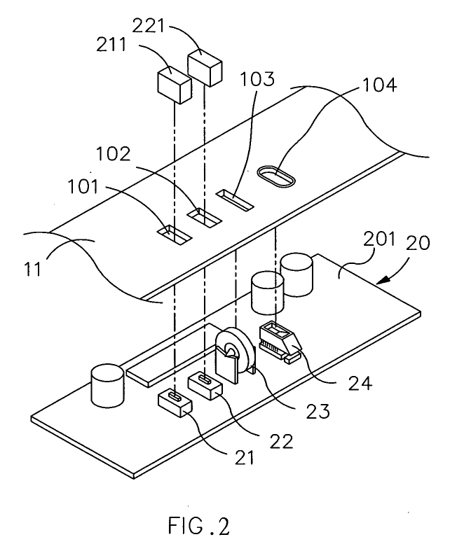

Referring to FIG. 2, the keyboard 10 includes a control panel 11 on which the cursor controller 20 is provided. A first aperture 101, a second aperture 102, a slot 103 and a window 104 is defined therein. The cursor controller 20 includes a circuit board 201 on which the first key unit 21, second key unit 22, scroll wheel unit 23 and photo-sensor 24 are provided. The circuit board 201 is located under the control panel 11. The first key unit 21 is exposed from the first aperture 101. A first cap 211 is attached to the first key unit 21 so that the user can easily use a thumb to press the first key unit 21 via the first cap 211. The second key unit 22 is exposed from the second aperture 102. A second cap 221 is attached to the second key unit 22 so that the user can easily use a thumb to press the second key unit 22 via the second cap 221. The scroll wheel unit 23 is exposed from the slot 103 so that the user can easily rotate the scroll wheel unit 23 with a thumb. The photo-sensor unit 24 is exposed from the window 104 so that the photo-sensor unit 24 can easily sense the movement of a thumb of the user when the user moves the thumb over the window 104. On sensing the movement of the thumb, the photo-sensor unit 24 causes the cursor to move on the screen via the circuit board 201.

The position of the cursor controller 20 on the control panel 11 is not limited. However, to facilitate the user using the cursor controller 20 and the standard keys alternatively without having to move his arms, it is preferred that the cursor controller 20 is located closer to the user than the standard keys are. More preferably, the cursor controller 20 is located near a space key of the keyboard 10. Therefore, the user can operate the cursor controller 20 with the thumbs and operate the standard keys with the other fingers. The user does not have to move his arms at all or just a little bit, thus canceling the risks of exhaustion or stress that would otherwise be caused by a bad gesture.

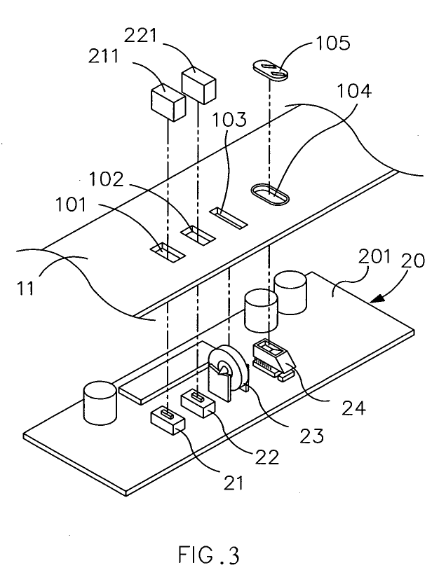

Referring to FIG. 3, there is shown a keyboard according to a second embodiment of the present invention. The second embodiment is like the first embodiment except including a lens 105 fit in the window 104 for protective purposes. Thus, the user can move his finger, a pen or a rod on the lens 105 and let the photo-sensor unit 24 sense the movement without having to worry about damaging the photo-sensor unit 24. The lens 105 protects the photo-sensor unit 24 from contaminant and hence ensures the sensibility of the photo-sensor unit 24.

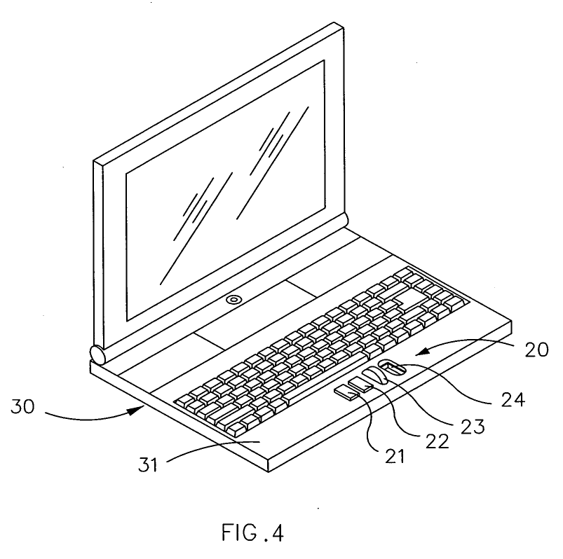

Referring to FIG. 4, there is shown a keyboard according to a third embodiment of the present invention. The third embodiment is like the first or second embodiment except that it is used in a laptop computer instead of a desktop computer.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A keyboard comprising a control panel and a cursor controller comprises:
a first key unit provided on the control panel;
a second key unit provided on the control panel; and
a photo-sensor unit provided on the control panel so that when a user moves his finger over the photo-sensor unit, the photo-sensor unit senses the movement and causes a cursor to move on a screen of a display of a computer used with the keyboard.

2. The keyboard according to claim 1, wherein the cursor controller comprises a scroll wheel unit provided on the control panel

3. The keyboard according to claim 2, wherein the first and second key units, scroll wheel and photo-sensor are located sequentially from left to right.

4. The keyboard according to claim 1, wherein the cursor controller is located closer to the user than standard keys of the keyboard are.

5. The keyboard according to claim 4, wherein the cursor controller is located near a space key of the keyboard.

6. The keyboard according to claim 1, wherein the control panel comprises a first aperture defined therein, a second aperture defined therein and a window defined therein, and the cursor controller comprises a circuit board on which the first and second key units and photo-sensor are provided, and the circuit board is located below the control panel so that the first key unit is exposed from the first aperture, that the second key unit is exposed from the second aperture and that the photo-sensor is exposed from the window.

7. The keyboard according to claim 6, wherein the control panel comprises a lens fit in the window for protective purposes.

8. The keyboard according to claim 2, wherein the control panel comprises a first aperture defined therein, a second aperture defined therein, a slot defined therein and a window defined therein, and the cursor controller comprises a circuit board on which the first and second key units, scroll wheel and photo-sensor are provided, and the circuit board is located below the control panel so that the first key unit is exposed from the first aperture, that the second key unit is exposed from the second aperture, that the scroll wheel is exposed from the slot and that the photo-sensor is exposed from the window.

9. The keyboard according to claim 8, wherein the control panel comprises a lens fit in the window for protective purposes.
